(19) United States
(12) Patent Application Publication
(10) Pub. No.: US 2007/0211498 A1
(43) Pub. Date: Sep. 13, 2007

(54) BOOST CONVERTER

(75) Inventor: Dolf Henricus Jozef Van Casteren, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,266

(22) PCT Filed: Apr. 25, 2005
(86) PCT No.: PCT/IB05/51337

§ 371 Date: Oct. 25, 2006

(30) Foreign Application Priority Data
Apr. 29, 2004 (EP) 04101856.5

(51) Int. Cl. H02M 3/335

(52) U.S. Cl. 363/16; 315/307

(57) ABSTRACT

A boost converter comprising an optional RFI-filter, a boost inductor (LB), two switch transistors connected in series (t2, T3) and at least one diode (D6, D7). The boost inductor is connected in series with the switch transistors directly to the AC mains voltage for producing a boosted AC voltage. The boosted AC voltage is rectified by a voltage doubling circuit, or alternatively with a full bridge rectifier. A control circuit controls the switch transistors. By arranging the boost inductor in the AC part, the inductor can be made considerably smaller. Moreover, several diodes can be excluded, resulting in a high efficiency, especially at low mains voltages below 3 times the output DC voltage. The boost converter is suitable for a mains AC voltage of 80 to 140 V for a supply of 410 V DC.

### FIELD OF INVENTION

The present invention relates to an input stage of a full electronic ballast comprising a boost converter.

### BACKGROUND OF INVENTION

A previously known boost converter comprises a full bridge rectifier connected to the AC mains voltage to provide a pulsating DC voltage, which is feed to a boost circuitry. The boost circuitry comprises a boost inductor, a switch transistor, a diode and a charging capacitor. First, the transistor is switched on and short-circuits the inductor between the positive DC voltage and the ground in order to build up magnetic energy in the boost inductor. Then, the transistor is switched off and the magnetic energy dissipates through the diode in order to charge the capacitor. In this way, the DC voltage can be boosted to high voltages. Such a boost converter may be used for increasing the DC voltage by a factor of up to about 2 with high efficiency. When the boost factor exceeds about 2, the efficiency becomes lower. An example of such a boost voltage converter is disclosed in for example U.S. Pat. No. 5,317,237, FIG. 2.

Another previously used method for increasing the available DC voltage from an AC voltage source is a voltage doubling or multiplying circuit design in which two or several diodes and capacitors are connected in series to form a stepwise increase of the available AC voltage, while simultaneously rectifying the AC voltage into a DC voltage. Such a circuit design is shown in for example WO 95/02311, FIG. 1, reference numeral 1.

The input stage of a full electronic ballast may be equipped with a traditional boost converter. The total circuit efficiency is very important to make operation in high temperature, miniaturized applications possible. The efficiency of the input stage in a ballast design is therefore of great importance.

### SUMMARY OF INVENTION

It is an object of the invention to provide a boost converter having high efficiency, especially for low mains operation.

Thus, there is provided a boost converter for converting an AC mains voltage, comprising an optional RFI-filter, a boost inductor, a switch and at least one rectifying element. According to the invention, said boost inductor is connected in series with said switch directly to the AC mains voltage, possibly with said RFI-filter inserted there between, for producing a boosted AC voltage as an output to a load element. By arranging the inductor in the AC portion of the boost converter, the current through the inductor does not pass through any diode during the energy charging phase of the boost cycle. Moreover, the current passes through the boost inductor in both directions. Furthermore, the boost inductor can be dimensioned smaller compared to the conventional design. All these measures result in power saving resulting in a high efficiency of the boost converter.

The switch may comprise two transistors, a first one of which operates at the positive half cycle of the boosted AC voltage, and the other one of which operates at the negative half cycle of the boosted AC voltage. This makes it possible to use the inductor in the AC portion of the boost converter. Such transistors may be MOSFET transistors, such as NMOSFET.

The boosted AC voltage may be rectified by a voltage multiplying circuit, such as a voltage doubling circuit. Then, the boosted AC voltage is rectified by a first rectifying element to charge a first capacitor during a positive half cycle of the boosted AC voltage, and is rectified by a second rectifying element to charge a second capacitor during a negative half cycle of the boosted AC voltage for producing a boosted DC voltage. In this circuit design, only two diodes are required. Consequently, the power consumption of the diodes is reduced compared to the conventional design resulting in high efficiency. Moreover, because of the voltage doubling circuit, the boost inductor does not need to boost the voltage with a high factor, whereby the efficiency is maintained at a high level.

In order to control the operation, first and second capacitors are connected in series between the drains of each transistor. The interconnection of the capacitor is connected to a zero current detecting circuit, which is referenced to a virtual ground connected to the interconnected sources of the transistors, whereby a zero current signal is obtained.

The boost converter of the invention may also be used at high AC voltages whereby the voltage doubling circuit is replaced by a full bridge. The two circuits may be combined by the use of a switch.

### BRIEF DESCRIPTION OF DRAWINGS

Further objects, features and advantages of the invention will become evident from a reading of the following description of several elucidating embodiments of the invention with reference to the appended drawings, in which:

FIG. 1 is a circuit diagram of a boost converter according to the prior art,

FIG. 2 is a circuit diagram of a boost converter including a bidirectional switch,

FIG. 3 is a circuit diagram of the boost converter of FIG. 2 connected to a voltage doubling circuit according to the present invention,

FIG. 4 is a circuit diagram of the boost converter of FIG. 2 connected to a full bridge rectifying circuit according to the present invention,

FIGS. 5a and 5b are circuit diagrams of alternatives of switch transistors,

FIG. 6 is a circuit diagram according to FIG. 3 for the positive current half-period,

FIG. 7 is a circuit diagram according to FIG. 6 for the negative current half-period,

FIG. 8 is a curve diagram showing the efficiency of the conventional boost converter compared to the inventive boost converter, and

FIG. 9 is a circuit diagram of an embodiment of the boost converter of FIG. 3.

### DESCRIPTION OF EMBODIMENTS OF THE INVENTION

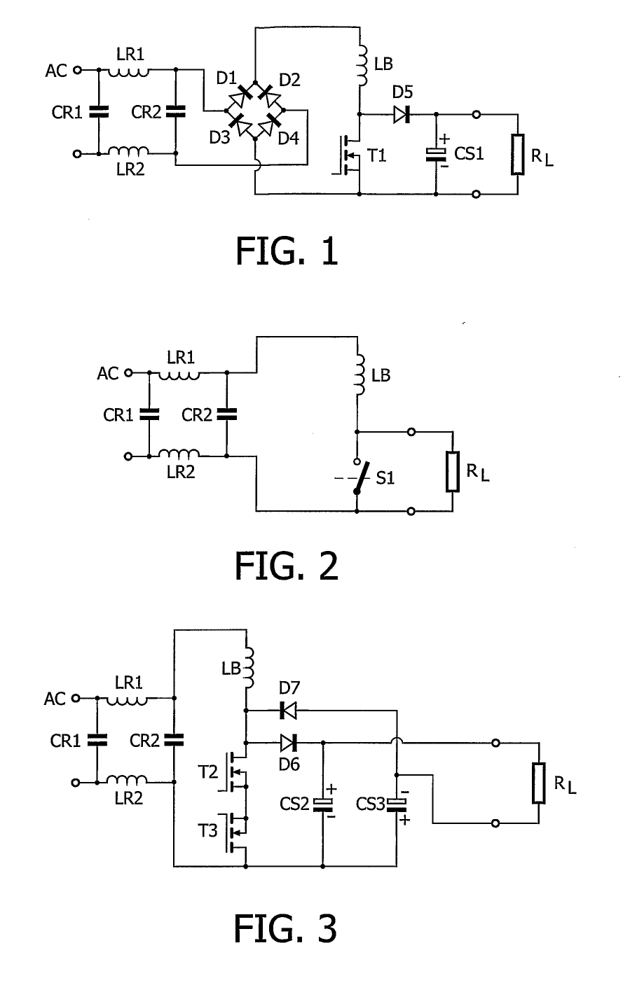

FIG. 1 discloses a schematic diagram of a conventional boost circuit, comprising an AC mains supply voltage of for example 230 V with a frequency of 50 to 60 Hz, an RFI filter comprising two inductors LR1 and LR2 and two capacitors CR1 and C , a full bridge rectifier comprising four diodes D1, D2, D3, D4, a boost inductor LB, a MOSFET switch transistor T1, a charge diode D5 and a charge capacitor CS1, all components interconnected as shown in FIG. 1.

The bridge rectifier provides a pulsating DC voltage having an amplitude of 324 V. This voltage is applied over the boost inductor LB. and the transistor T1. When the transistor is switched on by a control circuit (not shown), current starts to build up in the boost inductor. When a sufficient current has been generated and a sufficient energy has been stored in the inductor, the transistor is switched off as rapidly as possible. The energy in the inductor is now given off via the diode D5 to the charging capacitor CS1. An induced voltage is developed over the boost inductor that adds to the DC voltage. Thus, a high voltage may be charged to the capacitor CS1. The transistor is switched with a high frequency, such as 100 kHz. The voltage is boosted. A doubling of the voltage is easily obtained. Thus, a voltage of 410 V may be achieved over the charging capacitor CS1. This voltage may be used by a load RL for any purpose, such as a lamp driver for a fluorescent lamp or a HID (high intensity discharge) lamp.

The output voltage may be controlled by the control circuit.

If this circuit design should be used for a large range of mains voltages, such as from 80 V to 277 V, the efficiency of the circuit cannot be maintained for all mains voltages. When the mains voltage is low, the boost circuit must boost the voltage by a factor of more than about 2, which means that the boost circuit has lower efficiency. Moreover, if the circuit is designed for such a large range of mains voltages, the boost inductor LB must be designed for the worst condition, leading to large inductors and low efficiency.

The present invention is based on the finding that the boost inductor does not have to be used in the DC portion but may be arranged before rectifying, i.e. in the AC portion. By moving the boost conductor to a position before the rectifier, a boost converter with superior efficiency may be constructed, especially for low AC mains voltages.

A circuit design incorporating the principles of the invention is shown in FIG. 2. FIG. 2 discloses a circuit diagram of a first embodiment of the invention. The same components have the same reference numerals. Thus, an AC mains voltage is connected to an RFI filter comprising inductors LR1, LR2 and capacitors CR1, CR2. The RFI filter may be left out in certain applications, or other types of RFI filters may be used. The AC output voltage of the RFI filter is directly connected to the boost inductor LB. in series with a switch S1 shown as a mechanical switch. The output, i.e. the connection between the inductor and the switch is connected to a load RL.

The operation is the following. When the AC voltage is positive, a current starts to build up through the inductor LB when the switch S1 is switched on. Now, the output voltage is zero, since it is short-circuited by the switch S1. When the current has been built up to a sufficient value, as controlled by a control circuit, the switch S1 is opened. Then, the inductor tries to maintain the current prevalent in the inductor and drives a current through the load RL. The necessary voltage to drive the current is obtained by the positive voltage from the mains supply combined with a positive voltage induced by the inductor. Now, a positive voltage is present over the load RL, until the energy in the inductor has been consumed and the current has decreased to zero. Then, a new cycle begins. The switch frequency of the transistor can be about 50 to 200 kHz depending on the application.

When the mains voltage is negative, a negative current is built up in the inductor when the switch is closed while the output voltage is kept at zero, since it is short-circuited by the switch S1. When the negative current has been built up to a sufficient value, as controlled by the control circuit, the switch is opened. The inductor tries to maintain the negative current prevalent in the inductor and drives a negative current trough the load RL. The necessary voltage to drive the current is obtained by the negative voltage from the mains supply combined with a negative voltage induced by the inductor. Now, a negative voltage is present over the load RL, until the energy in the inductor has been consumed and the voltage of the mains supply increases to zero. Then the cycle is repeated.

In this way, a boosted AC voltage is obtained over the load RL. This boosted AC voltage can be rectified to provide a boosted DC voltage. This is shown in FIG. 3.

FIG. 3 discloses that the switch S1 has been replaced by two MOSFET switch transistors T2 and T3 connected in series. Transistor T2 is switched on during the start of the positive period when the current passes downwards in FIG. 3. In this mode of operation, transistor T3 acts as a diode passing the current in the opposite direction of the normal, and a positive current is built up in inductor LB. When transistor T2 is switched off, the inductor maintains the positive current by passing a current through diode D6 to charge capacitor CS2 by a boosted voltage. During the negative half-period, transistor T3 conducts current in the direction upwards in FIG. 3 and transistor T2 acts as a diode, whereby negative current is built up in inductor LB. When the transistor T3 is switched off, the negative current is passed through diode D7 to charge capacitor CS3 with a boosted negative voltage. The load RL is connected between the positive terminal of capacitor CS2 and the negative terminal of capacitor CS3, which means that the diodes D6 and D7 and the capacitors CS2 and CS3 operate as a voltage doubling circuit. Both transistors are normally turned on simultaneously, and the transistor acting as a diode is paralleled with a resistive channel of the corresponding transistor.

It is mentioned that further diodes and capacitors may be connected to form a multiplying circuit with a factor larger than two, but then again the efficiency is reduced.

In the circuit of FIG. 1, the current passes through two diodes, the inductor LB and the transistor during the on-period of the transistor, namely D1, LB, T1, D4 during the positive half-period and D2, LB, T1 and D3 during the negative half-period. During the off-period of the transistor, the current passes through diode D5 instead of the transistor.

In the circuit of FIG. 3, the current passes through the inductor and two transistors, one of which operates as a diode, during the on-period of the transistor, namely LB., T2, T3 (diode). During the off-period of the transistor, the current passes through the inductor and diode D6 (positive half-period) or D7 (negative half-period).

Thus, in the circuit of FIG. 3 compared to the circuit of FIG. 1, the power dissipation of one diode is saved in the on-period and the power dissipation of two diodes is saved in the off-period. In addition, the boost inductor in FIG. 3 can be constructed smaller, because the inductor does not need to boost the voltage to more than half that of the circuit of FIG. 1. In fact, the inductor in FIG. 3 can be reduced to about one fourth of the size of the inductor of FIG. 1. This will save power also in the inductor. Thus, the efficiency of the circuit of FIG. 3 is considerably higher than the efficiency of the circuit of FIG. 1.

In principle, if the intended load DC voltage is 410 V, the circuit of FIG. 3 can only be used if the AC mains voltage is below about 145 V. An AC voltage of 145 V corresponds to an amplitude of 205 V and since a voltage doubling is used, D6, D7, CS2, CS3, the output voltage will be 410 V without any boost of the voltage. However, a margin of 20 to 30 V is needed for correct operation.

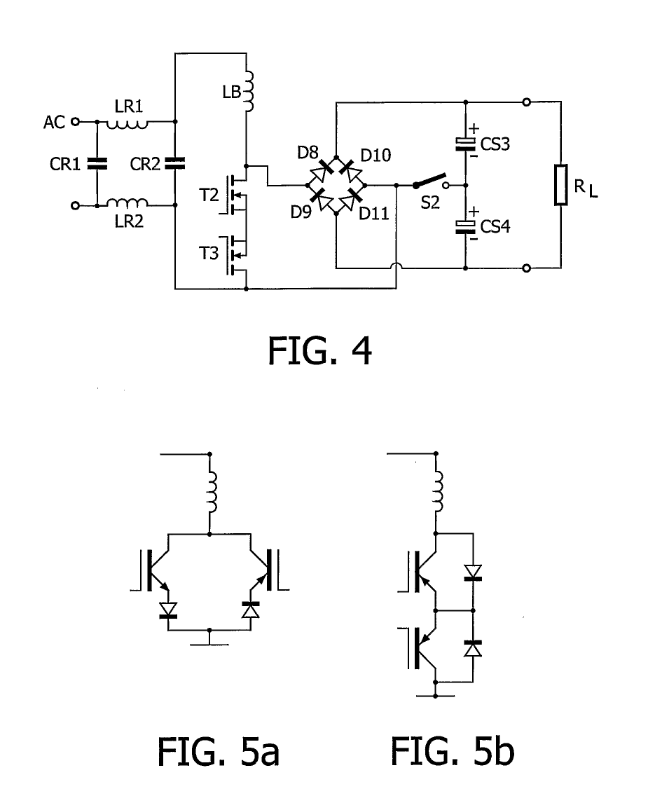

If the AC mains voltage is higher than 145 V, the output voltage will increase over 410 V. In this situation, the voltage doubling circuit may be replace by a full bridge rectifier circuit as shown in FIG. 4, which does not double the voltage. Thus, the AC mains voltage may in principle be up to 290 V. However, in the circuit of FIG. 4, the current passes through an extra diode in the off-period, which means that the efficiency is lower compared to the circuit of FIG. 3.

The circuits of FIG. 3 and FIG. 4 may be combined by adding a switch S2 in the circuit of FIG. 4 as shown. When the switch S2 is open, which is the high mains voltage position (145 V to 290 V) of the switch, the circuit operates as a full bridge rectifier according to FIG. 4 without voltage doubling. When the switch S2 is closed, which is the low mains voltage position (72 V to 145 V), the circuit operates as a voltage doubling circuit according to FIG. 3. The mechanical switch S2 may be replaced by a solid state switch, but will then consume power thereby lowering the efficiency of the circuit design. Since the circuit operates at a high frequency as mentioned above, in the range of 50 to 200 kHz, the power diodes D8 and D9 are high speed diodes. However, diodes D10 and D11 can be ordinary, cheap diodes, since they only conduct current back to the AC mains supply inwards the circuit.

It is mentioned that the voltages explicitly given above are only for explaining the invention and the principles of the invention can be used with advantage at other voltages as well, including both lower and higher voltages.

It is mentioned that the two capacitors CS3 and CS4 may be combined to one capacitor, if the switch S2 is not used.

The MOSFET switch transistors disclosed in FIGS. 3 and 4 may be replaced by insulated gate bipolar transistors (IGBT) or conventional bipolar transistors, which may be protected against reverse high voltages by a diode as shown in FIG. 5a and FIG. 5b. The same considerations as for the MOSFET transistors apply as to power dissipation.

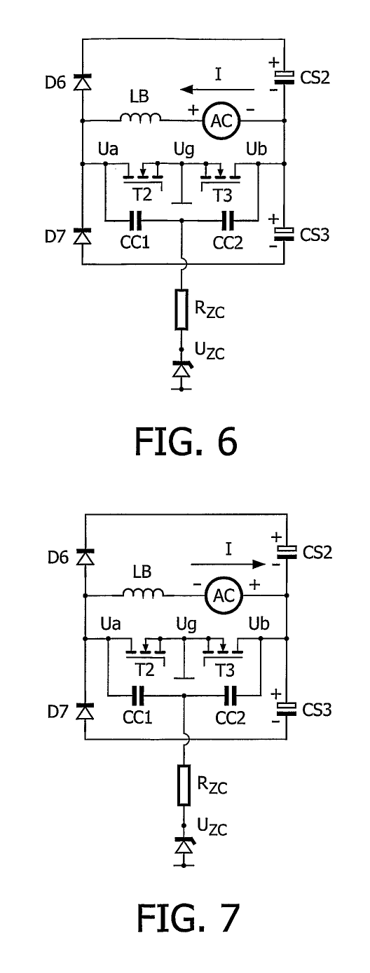

FIG. 6 discloses the circuit design of FIG. 3 including a basic control circuit comprising two capacitors CC1 and CC2 connected in series between the drains of the two transistors, which are named node Ua and Ub respectively. The interconnected sources of the two transistors, called node Ug is referenced to a floating ground. The interconnection between the capacitors CC1 and CC2, node Uc, is connected via a resistor Rzc to a zero current detecting input Uzc of a control circuit (not shown).

The positive half-period is shown in FIG. 6, in which the current passes through the inductor towards the left in FIG. 6. Transistor T2 is initially conducting and charging the inductor. During this period, all nodes Ua, Ub, Ug, Uc and Uzc are at 200 V (with reference to the negative terminal of capacitor CS3 and assuming that the intended DC voltage is 400 V).

When transistor T2 switches off, node Ua immediately rises to 400 V while node Ub is maintained at 200 V, which means that node Uc rises to 300 V. Node Ug, the floating ground, is maintained at 200 V since the body diode of transistor T3 is still conducting. This means that the zero current input is “armed” by a positive going edge. exceeding 2.3 V.

When the inductor current reverses direction, a zero moment takes place, the floating ground Ug is still via body diode T3 connected to node Ub. Next, the capacitive divider node Uc is falling in relation to the floating ground Ug. This leads to a negative edge on the zero current input. When the voltage falls below 1.1 V, the MOSFET T2 is turned on again.

The negative half-period is shown in FIG. 7. Negative current passes through the inductor to the right in FIG. 7. During the transition from the on to the off state, the floating ground Ug is via body diode of transistor T2 connected to node Ua. Subsequently, the capacitive divider node Uc is rising compared to the floating ground Ug. This means that the zero current input is “armed” by a positive going edge exceeding 2.3 V.

When the inductor current reverses direction, a zero current moment takes place, the floating ground Ug is still via body diode of transistor T3 connected to node Ua, because the body diode has a huge recovery charge and large recovery time, especially when a small current is flowing in reverse direction. Next, the capacitive divider node Uc is falling in relation to the floating ground Ug. This leads to a negative edge on the zero current input. When the voltage falls below 1.1 V, the MOSFET T2 is turned on again.

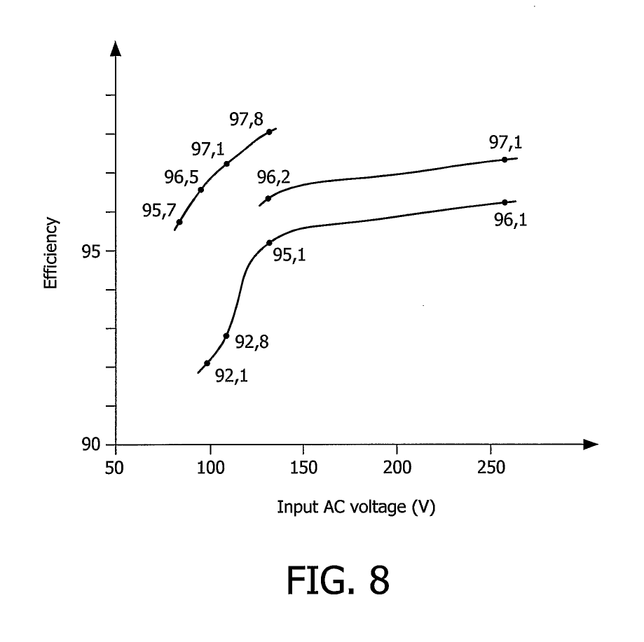

The power losses in a conventional boost converter according to FIG. 1 and an inventive boost converter according to FIG. 3 and FIG. 4 have been measured with the following conditions: Input AC mains voltage: 80 V, Uout: 410 V; Pout: 150 W. The efficiency appears from the diagram of FIG. 8. As can be appreciated from FIG. 8, the efficiency of the boost converter with voltage doubling circuit of FIG. 3, shown by the upper curve is considerably higher than the efficiency for the conventional boost converter shown by the bottom line, especially at low AC mains voltages. The boost converter with a full bridge rectifier according to FIG. 4 is shown in between.

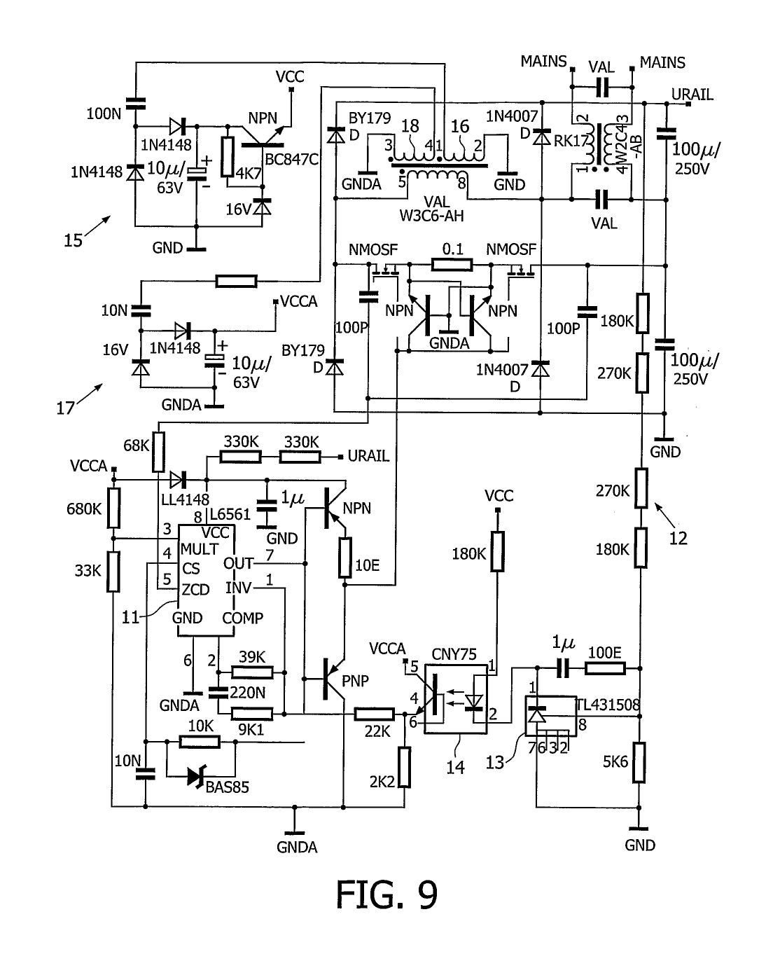

A complete scheme of the boost converter according to FIG. 3 is shown in FIG. 9. The MOSFET transistors T2, T3 are NMOSFET. The floating ground is named GNDA and the actual ground is named GND.

The control circuit 11 is built around a conventional control IC: L6561, which comprises a zero current detection port at pin 5 connected to the capacitor divider node Ug. The ground terminal of the IC, pin 6 is connected to the floating ground node Ug or GNDA. The gates of the two transistors are both connected to the output of the IC, pin 7.

Feedback is arranged by a resistor divider network 12, which is connected to a voltage reference 13. Since the resistor divider network and voltage reference are referenced to the real ground GND and not to the floating ground GNDA, as are the IC control circuit, an opto-coupler 14 is arranged between the two circuits.

Supply voltage to the voltage reference and opto-coupler may be provided by a low voltage supply VCC circuit 15 arranged around an auxiliary coil 16 of the boost inductor. The supply provides a voltage of about 16 V with reference to the actual ground GND as controlled by a zener diode.

Supply voltage VCCA to the IC control circuit L6561 is provided by a similar independent low voltage supply circuit 17 arranged around another auxiliary coil 18 of the boost inductor. A zener diode controls the voltage to 16 V.

It is mentioned that the control circuit operation could be performed in software by a program embodied in for example an ASIC (application specific integrated circuit) or a logical array.

The control circuit comprises also an overcurrent protection. When the maximum current limit is reached, the two active devices T2 and T3 are turned off.

The boost converter disclosed above has a very high efficiency. This is of importance at the construction of a boost converter that is to be made as small as possible. By the invention, the boost inductor can be decreased considerable, which means a saving of space. Moreover, the components can be miniaturized, since the power dissipation is very low. All these measures result in a boost converter that is less expensive. Moreover, the life-time of the boost converter may be extended due to the low heat dissipation.

It is mentioned that the expression “comprising” does not exclude other elements or steps and that “a”0 or “an” does not exclude a plurality of elements. Moreover, reference signs in the claims shall not be construed as limiting the scope of the claims.

Hereinabove has been described several embodiments of the invention with reference to the drawings. A skilled person reading this description will contemplate several other alternatives and such alternatives are intended to be within the scope of the invention. Also other combinations than those specifically mentioned herein are intended to be within the scope of the invention. The invention is only limited by the appended patent claims.

1. A boost converter for converting an AC mains voltage, comprising an optional RFI-filter, a boost inductor, a switch and at least one rectifying element, characterized in that said boost inductor (LB) is connected in series with said switch (S1) directly to the AC mains voltage, possibly with said RFI-filter (LR1, LR2, CR1, CR2) inserted there between, for producing a boosted AC voltage as an output to a load element (RL).

2. The boost converter of claim 1, characterized in that said switch comprises two transistors (T2, T3), a first one of which operates at the positive half cycle of the boosted AC voltage, and the other one of which operates at the negative half cycle of the boosted AC voltage.

3. The boost converter of claim 1, characterized in that said transistors are MOSFET transistors, such as NMOSFET.

4. The boost converter of claim 1, characterized in that said boosted AC voltage is rectified by a voltage multiplying circuit, such as a voltage doubling circuit (D6, D7, CS2, CS3).

5. The boost converter of claim 4, characterized in that said boosted AC voltage is rectified by a first rectifying element (D6) to charge a first capacitor (CS2) during a positive half cycle of the boosted AC voltage, and is rectified by a second rectifying element (D7) to charge a second capacitor (CS3) during a negative half cycle of the boosted AC voltage for producing a boosted DC voltage.

6. amended) The boost converter of claim 1, characterized in that said boosted AC voltage is rectified by a full bridge rectifier (D8, D9, D10, D11) for producing a boosted DC voltage.

7. The boost converter of claim 5, characterized by switches (S1, S2, S3) for converting said full bridge rectifier to a voltage doubling circuit.

8. The boost converter of claim 2, characterized by a first and a second capacitor connected in series between the drains of each transistor, the interconnection of the capacitor being connected to a zero current detecting circuit, which is referenced to a virtual ground connected to the interconnected sources of the transistors, whereby a zero current signal is obtained.
